(19) United States
(12) Patent Application Publication
(10) Pub. No.: US 2004/0244722 A1
(43) Pub. Date: Dec. 9, 2004

(54) "Deer zapper" a deer repellant/deterant device

(76) Inventors: Lee Allen Scharenberg, Coeur d'Alene, ID (US); Bonnie Rae Scharenberg, Coeur d'Alene, ID (US)

Correspondence Address: Lee A. Scharenberg, Suite C-2, 118 N 7th St., Coeur d'Alene, ID, 83814, US

(21) Appl. No.: 10/457,085

(22) Filed: Jun. 9, 2003

(51) Int. Cl. A01K 37/00

(52) U.S. Cl. 119/712

(57) ABSTRACT

The claimed device, incorporating an adjustable electrode design, where the filaments of the electrode are positioned in an array pattern by the “halo” housing cap improves the art of deterring deer from browsing on desirable garden plants, by taking advantage of the browsing habits of deer, and the capacity of the claimed device to create an electric shock barrier between the protected plant and an approaching deer. This design improves the art as it uses the plant itself as the “bait” rather than a scent or bait component in the device, and interdicts the deer as it approaches the plant to feed, thus repelling the deer from the plant, not a bait component in a device, as other deer repellent/deterrent designs incorporate.

### REFERENCES

REFERENCES
U.S. Pat. Documents

| | | |
|---|---|---|
| 5,8094,818 | Betzen | April 1999 |
| 6014951 | Betzen | January 2000 |
| 6125595 | Showalter | October 2000 |
| 6550428 | Betzen | April 2003 |

### FIELD OF THE INVENTION

This claimed device pertains to electronic animal repelling/deterrent devices, specifically designed to reduce or prevent damage to ornamental, and garden plants, common to households and commercial gardens, where herbivores such as deer, are responsible for said damage.

A. U.S. Pat. No. 5,894,818 shows an electric deer deterrent device, which incorporates a bait attractant component, internal energy producing and regulation components, and short single plane, electrodes. This device does not address the deer/plant damage problem cited because the device cannot create a “zone of potential contact” between said device and a selected plant. The device depends upon the bait attractant component, in-order to entice a deer to contact said device electrode. The device design protects the bait, not a plant or group of plants from deer depredation.

B. U.S. Pat. No. 6,014,951 shows an electric deer deterrent device, which incorporates a similar design as U.S. Pat. No. 5,894,818, a bait component, internal electric components with an electrode configuration. This device faces the same problems as previously mentioned. This device depends on bait to entice the deer, in order an electric shock can be delivered to the deer. A rose plant, desirable to the garden, 50 feet away from said device, is not likely to be protected, as claimed. This device also requires the deer to contact a positive and negative electrode simultaneously in order for the electric shock to be delivered to the deer. This approach to design limits the effectiveness of the design. Also, this design incorporates a bait attractant component, which simply trains a deer not to touch the device, rather than preventing the deer from eating plants in the vicinity of the device.

C. U.S. Pat. No. 6,125,595 shows a device, which incorporates an insulator housing/tube, with an electrode configuration essentially wrapped around the insulator housing/tube. This design specifically calls for and requires the use of 120 volt, alternating current, common to U.S. households. This design also incorporates a connection to a power source by means of a “male electric plug connector”, to be attached to the alternating 120 volt power source. The use of 120-volt alternating household current, common throughout the USA, is an especially bad choice for energy in this device. It is common knowledge, making contact with a 120 volt AC electric power source such as this device is at the very least, dangerous, and at worst, such contact with this device while standing on moist grass or soil, can kill a human being, thus limiting the device's application to garden use.

D. U.S. Pat. No. 6,550,428 is a design for a deer repelling, training device incorporating a baited, scent-producing component, an electrode configuration, of positive and negative charge, internal electronic power components. This device suffers from the same flaw previously mentioned. The device trains a deer to avoid said device, not a specific plant of the gardener's choosing. It is also necessary, as claimed for said device, for a deer to contact both positive and negative electrodes at the same time, for the electric shock to be delivered to the deer. Thus further reducing the device's effectiveness.

These designs fail, on the whole, and by design, to interdict a deer, while the deer attempts to browse on plants, and to create an unobtrusive barrier between deer and selected garden plants, of a gardeners choosing.

### SUMMARY OF THE INVENTION

This claimed electronic device is intended to impede and deter deer from browsing, feeding upon, and thereby causing damage to, selected and desirable ornamental and garden plants.

The advantages and benefits of the claimed device are:

1. Simplicity of design.

2. The claimed device does not ever require bait or scent components to be effective as deterrence to browsing or feeding deer.

3. Specifically, the claimed design allows the claimed device to be placed in direct proximity to the plant to be protected.

4. The insulator cap design allows the electrode component of the claimed device to create an area impedance, directly between the plant to be protected, and approach by a browsing or feeding deer. Further, the insulator cap design causes the electrode to spread over a “halo” contact zone around the protected plant, making it difficult for a browsing deer to feed, on the protected plant, without making contact with said electrode, thus receiving direct current shock.

5. Claimed device is charged by direct electric current; a non-lethal deterrence, rather than 120-volt alternating current conunon to households in the USA, which can be lethal to humans, and animals under conditions common to gardens. (That is, damp soil or wet grass conditions.)

6. The claimed device has no internal electric generation, or control components.

7. The claimed device does not rely on batteries for its electric charge.

8. The claimed device improves the art by taking advantage of the relationship between the browsing habits of common whitetail deer, and desirable plants intended for protection by the garden owner. Due to the claimed device design, said device can be placed in direct proximity to a plant, thus establishing a barrier, between said plant and said deer. As the deer exercises its browsing habits, it must approach a plant, protected by the device direct electric electrode “halo” barrier. The deer's intent to feed on said plant is interrupted as its head contacts the device electrode filaments, thus receiving a direct electric shock. The claimed device design is specific to protect a plant. The plant itself is the “bait” drawing the deer to said plant, contacting the claimed device, thus receiving electric shock as a deterrent.

9. The claimed device can be operated as a single unit, or in conjunction with multiple other claimed devices, in order to create a series of electronic shock barriers, protecting many plants, common to the same garden area.

10. The claimed device design does not impede the access or egress of the garden owner/operator to the garden area where the plants to be protected are located.

11. The claimed device is unobtrusive. Thus blending with the chosen ornamental design of the garden owner operator.

12. The device can operate in any weather condition.

13. The device requires no “recharge” time, after being contacted by a deer.

14. The claimed device can be placed to protect plants in accordance with gardener's knowledge of which plant he owns, are browsed upon by deer. Selective application is possible.

15. The insulation tube halo cap makes it possible to orient the tempered stainless steel wire filaments of the claimed device electrode in a pattern appropriate to the protected plant size and location. The electrode filaments can be selectively oriented in a 360 degree circular plane around the cap, as well as a 180 degree vertical pattern above the cap. By selecting the holes through which the electrode filaments are passed.

16. The claimed device electrode filaments can be withdrawn into, or extended from the insulation tube housing, through the insulation tube “halo” cap in order to adjust the electrode exposure as needed. As the electrode is extended, the diameter of the pattern of the filaments can be increased, or decreased as the electrode is withdrawn back into the tube.

### GUIDE TO DRAWINGS

FIG. 1 shows a drawing of the entire claimed device.

FIG. 2 shows the electrode components.

FIG. 3 shows the insulating “halo” cap.

FIG. 4 shows the insulating tube housing, the insulating tube stake pocket tube, and the stake pocket tube cap.

FIG. 5 shows the entire device with cutaway view exposing the internal components in place.

FIG. 6 demonstrates a side view of the claimed device placed in proximity to a plant.

FIG. 7 demonstrates a top view of the claimed device placed in proximity to a plant.

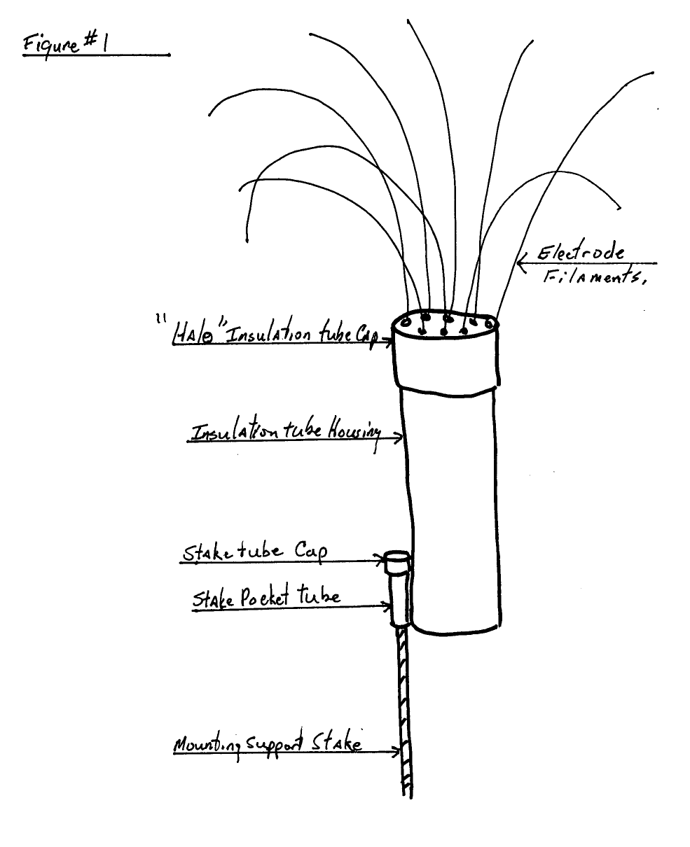

### DETAILED DESCRIPTION OF THE INVENTION

The claimed device is composed of the following parts:

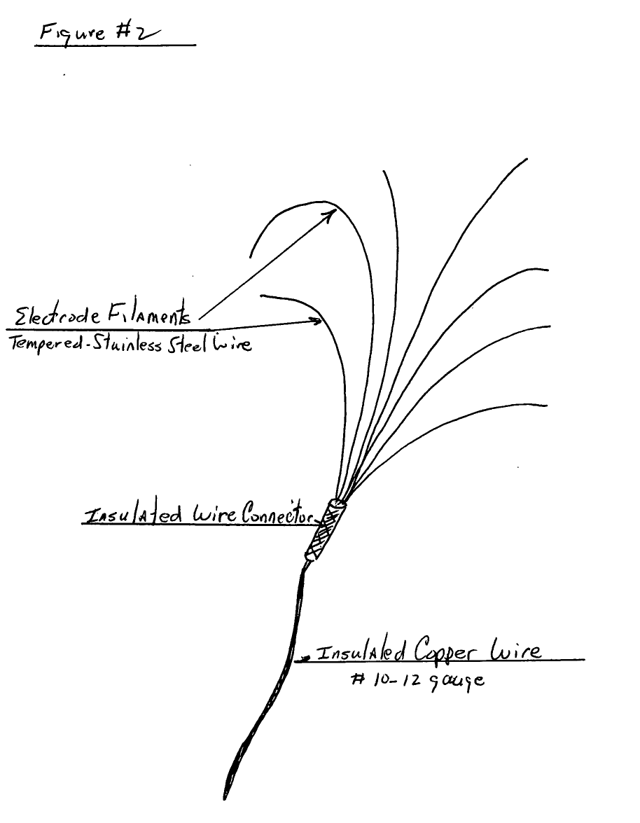

1.) An electrode made of multiple filaments of tempered stainless steel wire. The number of filaments can consist of eight or more (less as needed) individual pieces of tempered, stainless steel wire. A wire connector insulated with plastic cover; is crimped at the end of the stainless steel wire filaments. A length of insulated, copper core wire is inserted into the open end of said wire connector, and then crimped as shown in FIG. 2.

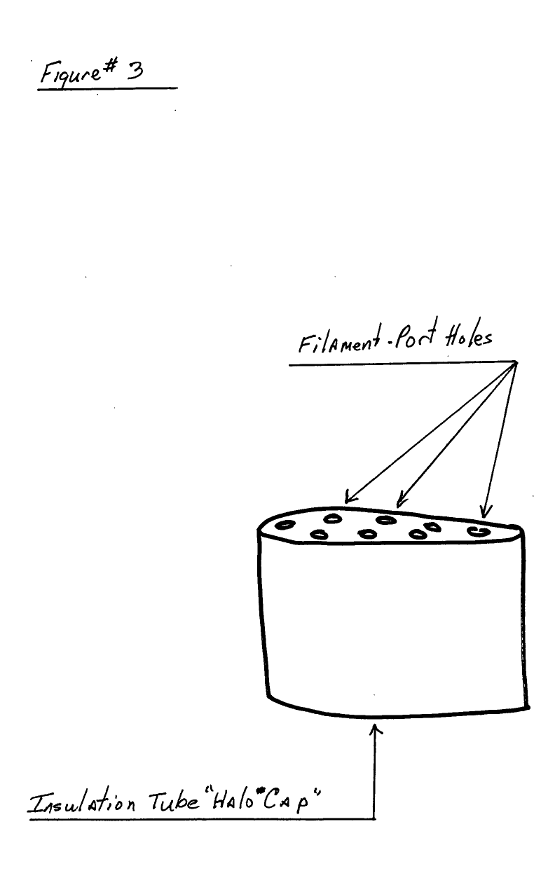

2.) A PVC pipe cap (polyvinyl chloride). ½ inch to 1-inch diameter as example. The cap is drilled on the closed end cover of said cap with multiple holes of approximately 1/32-inch diameter holes, as shown in FIG. 3.

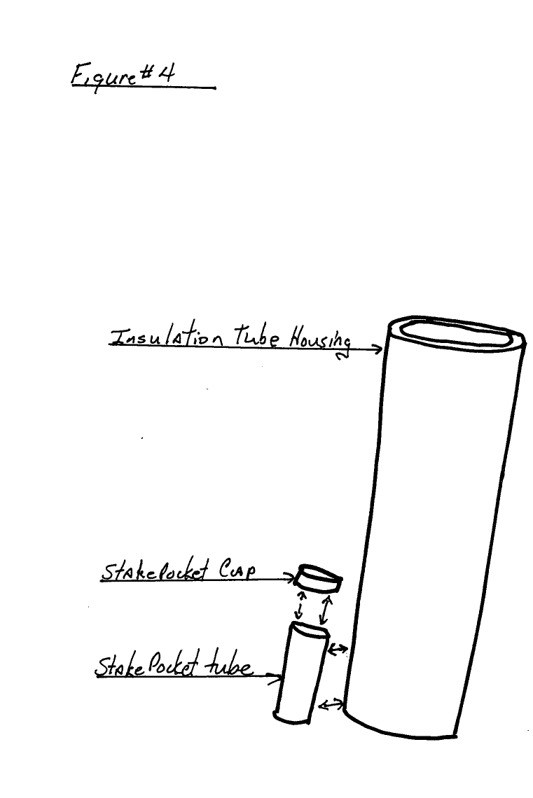

3.) An insulated housing tube composed of PVC (polyvinyl chloride) pipe, approximately ½ inch to 1-inch diameter; a tube length of twelve to eighteen inches is preferred but length can vary. Shown in FIG. 4.

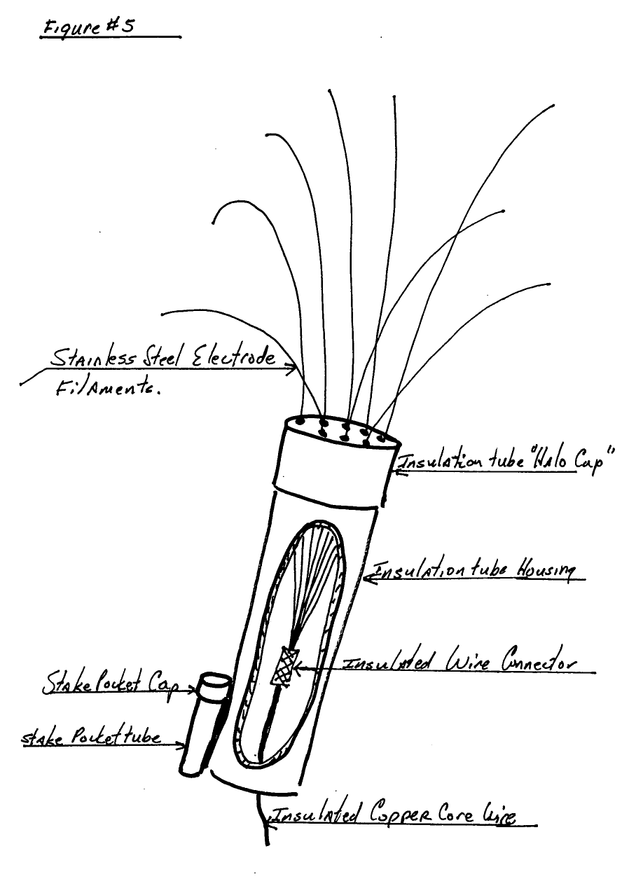

4.) A stake pocket tube composed of PVC (polyvinyl chloride) pipe of approximately ½ inch diameter, and length of 3 inches is preferred. Shown in FIG. 4. Said stake pocket tube is attached to the insulator tube housing as shown in FIGS. 4 and 5.

5.) A stake pocket tube cap composed of PVC (polyvinyl chloride) pipe cut is attached to the end of the stake pocket tube. As shown in FIG. 5 and FIG. 4.

6.) Connection of the stake pocket tube to the insulation tube housing, and the stake pocket tube cap to the stake pocket tube is accomplished with PVC (polyvinyl chloride) glue. Shown in FIG. 5.

7.) The electrode of said device, descnbed in previous section #1, of the detailed description, is inserted into the insulation tube housing, (FIG. 5). The filaments of the electrode of said device are passed through the drilled holes of the “halo” insulation tube cap (FIG. 5).

8.) The insulation tube cap is placed over the end of the insulation tube housing, opposite the stake pocket tube and cap. (FIG. 5).

9.) The length of the exposed electrode filaments can now be adjusted to desired exposed length, by sliding the filaments into or out of the insulation tube housing, through the drilled holes in the insulation tube “halo” cap.

10.) Direct current electricity is supplied to the claimed device by attaching the current source feed wire to the insulated, copper core wire. (FIG. 5).

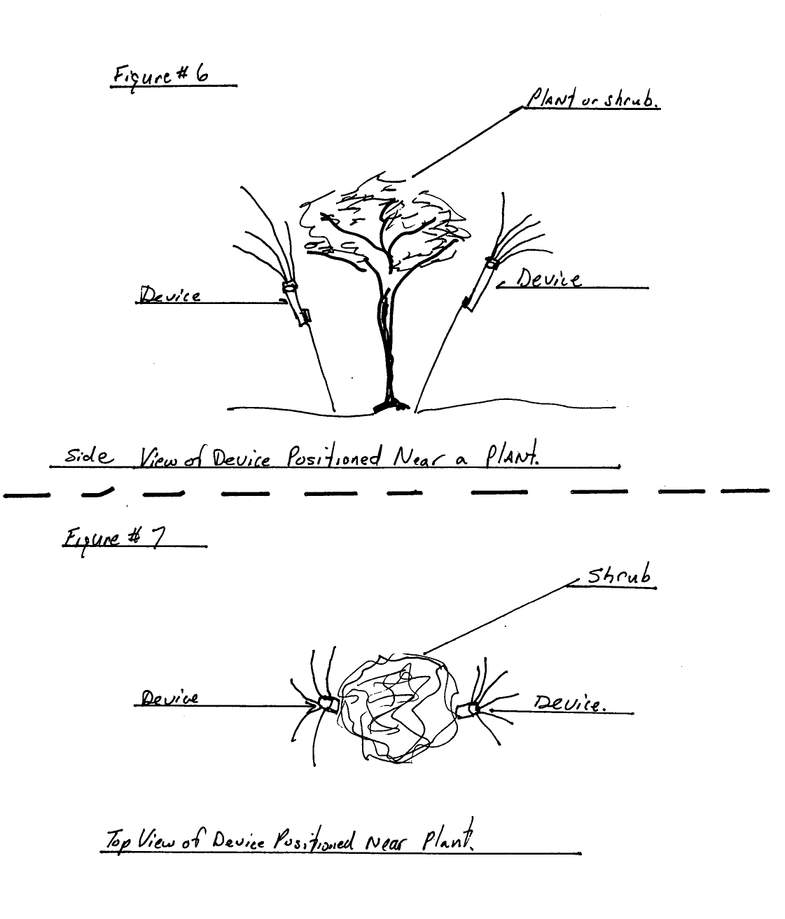

11.) The claimed device is placed in proximity to a selected plant, and mounted on a stake, to maintain position, in order to create a barrier between the protected plant, and a browsing deer. See FIG. 6 and 7.

What we claim as our invention is a direct electric deer deterrent/repellant device composed of the following parts:

1. A PVC, (polyvinyl chloride) tubular insulation housing; a multi-filament, tempered, stainless steel wire electrode, contained in the tubular insulation housing; a PVC, (polyvinyl chloride) insulation cap attached to the end of the insation tube housing, one end of each electrode filament wire passing through holes drilled in this insulation tube cap; an insulated wire connector, attached to and gathering one end of each electrode filament wire; an insulated, copper core wire, attached to the end of the insulated wire connector, opposite the point where the insulated wire connector is attached to the electrode filament wires; a PVC, (polyvinyl chloride) tubular, stake pocket, attached to the insulation tube housing, opposite the end of the insulation housing from the insulation tube cap and the exposed electrode filaments wires.
